(19) United States
(12) Patent Application Publication
(10) Pub. No.: US 2004/0084480 A1
(43) Pub. Date: May 6, 2004

(54) Pressurized container

(76) Inventors: Brett C. Domoy, Brewster, NY (US); Gary Albaum, Croton, NY (US)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(21) Appl. No.: 10/287,458

(22) Filed: Nov. 4, 2002

(51) Int. Cl. B67D 5/52

(52) U.S. Cl. 222/136; 222/145.5

(57) ABSTRACT

A container for mixing and dispensing separately stored substances is provided. The container has a number of inner chambers housed in an outer canister. Preferably, the outer canister stores a propellant that creates pressure in the inner chambers for mixing and then dispensing of the substances contained therein.

### BACKGROUND OF THE INVENTION

1. Field of the Invention

The present invention relates to pressurized containers. More particularly, the present invention relates to pressurized containers having two or more chambers.

2. Description of the Prior Art

Pressurized systems are widely used for dispensing a variety of consumer and industrial products. These systems, referred to as “aerosols,” typically include three components: (1) a product to be dispensed, (2) a propellant, and (3) a pressurized container. The container is typically cylindrical and is capable of withstanding moderate pressures. In operation, a push button or other actuator opens a valve, allowing the product to be expelled from an opening or nozzle. The propellant, which is typically a gas under ambient conditions, is expelled from the container with the dispensed product. These conventional aerosol devices suffer from the drawbacks of limiting the dispensed substance to one product and requiring mixing of the dispensed substance with the propellant.

In U.S. Pat. No. 4,469,252, an aerosol container having dual chambers is disclosed. The aerosol container has an outer container and an inner container housed therein. The outer and inner containers are coupled through dispensing valves and dispensing tubes. The inner container contains component B and a propellant, and the outer container contains component A. Due to the higher pressure within the inner container, component B and the propellant is propelled through the dispensing tube and dispensing valve and into the pressureless outer container where it mixes with component A. The mixture is then dispensed as a result of the introduction of the propellant into the outer container. While this device allows for two products to be mixed and dispensed, it suffers from the drawback of requiring mixture of substance B with the propellant.

### SUMMARY OF THE INVENTION

It is an object of the present invention to provide a container that allows for ejection of two or more substances from two or more distinct chambers.

It is another object of the present invention to provide such a container that allows for ejection of substances without mixing with propellant.

It is yet another object of the present invention to provide such a container that allows for ejection of substances from any orientation of the container.

It is a further object of the present invention to provide a filling process for this container.

These and other objects and advantages of the present invention are provided by the present invention that includes a container for separately storing under pressure two or more substances that will be mixed and then ejected from the container into atmosphere. The container has a rigid outer housing having an outer volume for containing a propellant and two or more flexible inner chambers. Each of the two or more inner chambers have an inner volume for containing a distinct substance and the two or more inner chambers are sealingly contained in the outer volume. The outer volume and the inner volumes are in fluid isolation from each other and the propellant exerts a force on the two or more inner chambers thereby increasing pressure in the inner volumes. The container also has a valve system having a mixing chamber in selective fluid communication with the two or more inner chambers and the atmosphere. Actuation of the valve system causes the substances to eject from the two or more inner chambers into the mixing chamber where the substances mix and then eject from the mixing chamber to the atmosphere.

The two or more inner chambers can be a first inner chamber and a second inner chamber. The first inner chamber can be sealingly contained in the second inner chamber. The outer housing, the first inner chamber and the second inner chamber can be concentrically aligned. The outer housing can have a substantially circular open end for insertion of the first inner chamber and the second inner chamber. The open end can have a flange adapted for sealing engagement with the valve system. The outer housing can be substantially cylindrical. The two or more inner chambers can be substantially cylindrical. The outer housing can be made of aluminum. The two or more inner chambers can be adjacently aligned.

The present invention also includes a container having a rigid outer housing with an outer volume for containing a distinct substance and two or more flexible inner chambers. Each of the two or more inner chambers have an inner volume. One of the two or more inner chambers contains a propellant and the other of the two or more inner chambers contains a distinct substance. The two or more inner chambers are sealingly contained in the outer volume. The outer volume and the inner volumes are in fluid isolation from each other. The propellant exerts a force on the other of the two or more inner chambers and the outer volume for increasing pressure in the inner volume of the other of the two or more inner chambers and the outer volume. The container also has a valve system having a mixing chamber in selective fluid communication with the other of the two or more inner chambers, the outer housing and the atmosphere. Actuation of the valve system causes the substances to eject from the other of the two or more inner chambers and the outer housing into the mixing chamber where the substances mix and then eject from the mixing chamber to the atmosphere.

The two or more inner chambers can be a first inner chamber and a second inner chamber. The first inner chamber can be sealingly contained in the second inner chamber. The outer housing, the first inner chamber and the second inner chamber can be concentrically aligned. The outer housing can have a substantially circular open end for insertion of the first inner chamber and the second inner chamber. The open end can have a flange adapted for sealing engagement with the valve system. The outer housing can be substantially cylindrical. The inner chambers can be substantially cylindrical. The outer housing can be made of aluminum. The two or more inner chambers can be adjacently aligned.

The present invention further includes a method of filling a first substance and a second substance in a container. The container has a rigid outer housing, a first flexible inner chamber and a second flexible inner chamber in fluid isolation from each other, and a valve system having a mixing chamber in selective fluid communication with the first and second inner chambers and the atmosphere, for selectively mixing and then ejecting the first substance and the second substance. The method has the steps of inserting the first inner chamber into the outer housing and filling the first inner chamber with the first substance; inserting the second inner chamber into the outer housing; sealingly securing the valve system to the outer housing, the first inner chamber and the second inner chamber so that the first inner chamber and the second inner chamber are in fluid communication with the mixing chamber; filling the outer housing with a propellant; and filling the second inner chamber with the second substance.

The second inner chamber can be inserted into the first inner chamber. Also, the second substance can be filled into the second inner chamber through the valve system.

Other and further objects, advantages and features of the present invention will be understood by reference to the following.

### BRIEF DESCRIPTION OF THE DRAWINGS

FIG. 1 is a schematic cross-sectional diagram of the container of the present invention;

FIG. 2a shows a first step in a method of filling the container of FIG. 1;

FIG. 2b shows a second step in the method of filling the container of FIG. 1;

FIG. 2c shows a third step in the method of filling the container of FIG. 1;

FIG. 2d shows a fourth step in the method of filling the container of FIG. 1;

FIG. 2e shows a fifth step in the method of filling the container of FIG. 1; and

FIG. 3 is a schematic cross-sectional diagram of the container of FIG. 1 with an applicator attached thereto.

### DESCRIPTION OF THE INVENTION

Referring to the drawings and, in particular, FIG. 1, there is shown a preferred embodiment of the container of the present invention generally represented by reference numeral 1. Container 1 has a first inner chamber 400, a second inner chamber 500 and a rigid aerosol outer canister or housing 600.

In this embodiment, container 1 preferably has two chambers 400 and 500 for dispensing two substances that will be described later in further detail. However, the present invention allows for any number of chambers to be housed in aerosol canister 600, depending upon the application of container 1. By way of example only, container 1 can be used for dispensing hair dye products that require mixture of two substances, i.e., a developer composition (“developer”) and a dye composition (“dye”). Other applications may require mixture and dispensing of more than two substances, which can likewise be accomplished by the present invention by using more than two chambers housed in aerosol canister 600.

Aerosol canister 600 creates a first volume 650. Preferably, aerosol canister 600 has a cylindrical shape, but other shapes may be used especially for other purposes, e.g., facilitating the filling and dispensing of container 1, strengthening the container and/or aesthetic appeal. Also, a variety of sizes of aerosol canister 600 can be used. Factors for the sizing of aerosol canister 600 include shelf height restrictions and volume of substances to be dispensed. In the preferred embodiment shown in FIG. 1, aerosol canister 600 is preferably made from aluminum, but other rigid materials may also be utilized including, e.g., steel or polyethylene perephthalate. Preferably, first volume 650 contains a propellant, such as liquefied hydrocarbons or compressed gases.

Aerosol canister 600 preferably has a top 620, an outer surface 630, and a bottom 660. Top 620 preferably has a canister rim or flange 675 that defines a canister opening 690. More preferably, top 620 has a tapered portion 695. Canister rim 675 is preferably concentrically aligned with aerosol canister 600. Canister rim 675 has a diameter large enough for the insertion of first chamber 400. Canister opening 690 is preferably circular in shape. Preferably, canister opening 690 has a diameter of about one inch. However, other shapes and diameters may also be used for canister opening 690.

Top 620 is adapted to receive a valve system or assembly 100. Valve system 100 has a hollow core defining a mixing chamber 230. Valve system 100 is adapted to sealingly engage with canister opening 690. In this embodiment, valve system 100 is crimped on canister rim 675 after first and second chambers 400, 500 have been inserted through canister opening 690. Thus, container 1 has three separately sealed volumes, i.e., first volume 650, second volume 450 and third volume 550. However, depending upon the application and the number of chambers used, a larger number of separately sealed volumes may be created.

Preferably, bottom 660 facilitates pressurization of aerosol canister 600 with a propellant. In this embodiment, bottom 660 is grommetted. However, aerosol canister 600 may be adapted with alternative means for pressurization of first volume 650 with a propellant, including an under the cup pressurization.

First chamber 400 has a chamber opening 420 with a diameter preferably slightly less than the diameter of canister opening 690. As described above, first chamber 400 is inserted through canister opening 690 prior to sealing container 1 with valve system 100. Chamber opening 420 is sealingly engaged with canister opening 690 and valve system 100.

Preferably, first chamber 400 is concentrically aligned with outer surface 630. First chamber 400 creates second volume 450. First chamber 400 is made from a flexible material that provides a barrier between first volume 650 and second volume 450 to prevent mixing of substances contained therein. In this embodiment, first chamber 400 is preferably made from a polymer including, e.g., nylons and/or ethylenes.

An example of first chamber 400 is disclosed in the co-pending and commonly owned U.S. Application entitled “Container” which has been filed evenly herewith (Attorney Docket No. G-00288), and the disclosure of which is incorporated herein by reference.

In this embodiment, first chamber 400 houses second chamber 500 by inserting second chamber 500 through chamber opening 420. Preferably, first chamber 400, second chamber 500 and aerosol canister 600 are concentrically aligned. However, alternative embodiments include having a number of chambers adjacent to each other within aerosol canister 600.

As described above, second chamber 500 is inserted through chamber opening 420 prior to sealing by valve system 100, and sealingly engages valve system 100. Second chamber 500 creates third volume 550. Second chamber 500 is made from a flexible material that provides a barrier between second volume 450 and third volume 550 to prevent mixing of substances contained therein. In this embodiment, second chamber 500 is preferably made from a polymer including, e.g., plastic.

Both first chamber 400 and second chamber 500 are sealingly engaged to, and operably connected with, valve system 100 to allow mixing of substances contained in second volume 450 and third volume 550, outside of first and second chambers 400 and 500, and then dispensing of the substances to the atmosphere. Preferably, the mixing of the substances occurs in mixing chamber 230. For example, valve system 100 can have a two-way valve in combination with a one-way valve to selectively allow substances from first chamber 400 and second chamber 500 to flow into the valve system for mixing and ejection. Additionally, valve system 100 could also have other combinations of one-way valves and a two-way valve to selectively allow flow of any number of substances from their corresponding separate chambers into valve system 100 where the substances are mixed and then ejected into the atmosphere.

An example of valve system or assembly 100 is disclosed in the co-pending and commonly owned U.S. Application entitled “Valve” which has been filed evenly herewith (Attorney Docket No. G-00287), and the disclosure of which is incorporated herein by reference.

By way of example, the present invention when used for hair dye products would require filling first chamber 400 with the developer and filling second chamber 500 with the dye. The pressure applied from the propellant in first volume 650 onto first chamber 400 increases the pressure in second volume 450, which in turn increases the pressure in third volume 550. When valve system 100 is actuated, the increased pressure in second and third volumes 450, 550 cause the substance in first chamber 400, i.e., the developer, and the substance in second chamber 500, i.e., the dye, to travel through the valve system, mix and then dispense into the atmosphere.

Valve system 100 allows one-way flow from second volume 450 (first chamber 400) and two-way flow with third volume 550 (second chamber 500). Valve system 100 allows second chamber 500 to be filled after insertion into canister 600. However, alternative embodiments can include one-way flow from second chamber 500 and two-way flow with first chamber 400.

In this embodiment, first chamber 400 has a variable capacity resulting from its shape, the use of pleated sides (not shown) and the material from which it is made. Once a substance, i.e., the developer, is filled into second volume 450 and a second substance, i.e., the dye, is filled into third volume 550, first chamber 400 takes an expanded shape as shown in FIG. 1. As the developer in second volume 450 is ejected, volume 450 is reduced as a result of the flexible material forming first chamber 400 and the pressure placed upon first chamber 400 by the propellant contained in first volume 650 of aerosol canister 600. Ejection of all of the developer from second volume 450 results in first chamber 400 collapsing. Likewise, as the substance, i.e., the dye, in third volume 550 is ejected, third volume 550 is reduced as a result of the flexible material forming second chamber 500 and the pressure placed upon second chamber 500 by the propellant contained in first volume 650 of aerosol canister 600. The pressure placed upon the outside of first chamber 400 and second chamber 500 from the propellant causes these chambers to substantially simultaneously collapse.

In an alternative embodiment having a number of chambers adjacent to each other in aerosol canister 600, the pressure applied from the propellant in first volume 650 onto the number of chambers, increases the pressure in the chambers.

Although in the preferred embodiment, the propellant is in outermost volume 650, i.e., aerosol canister 600, creating an inward pressure upon first and second chambers 400 and 500, alternatively, the propellant can be in middle volume 450, i.e., first chamber 400, or inner most volume 550, i.e. second chamber 500, to create pressure in the other volumes. Additionally, the use of one volume pressurizing the other volumes, e.g., first volume 650 pressurizing second and third volumes 450, 550 allows container 1 to mix and eject substances from any orientation of the container.

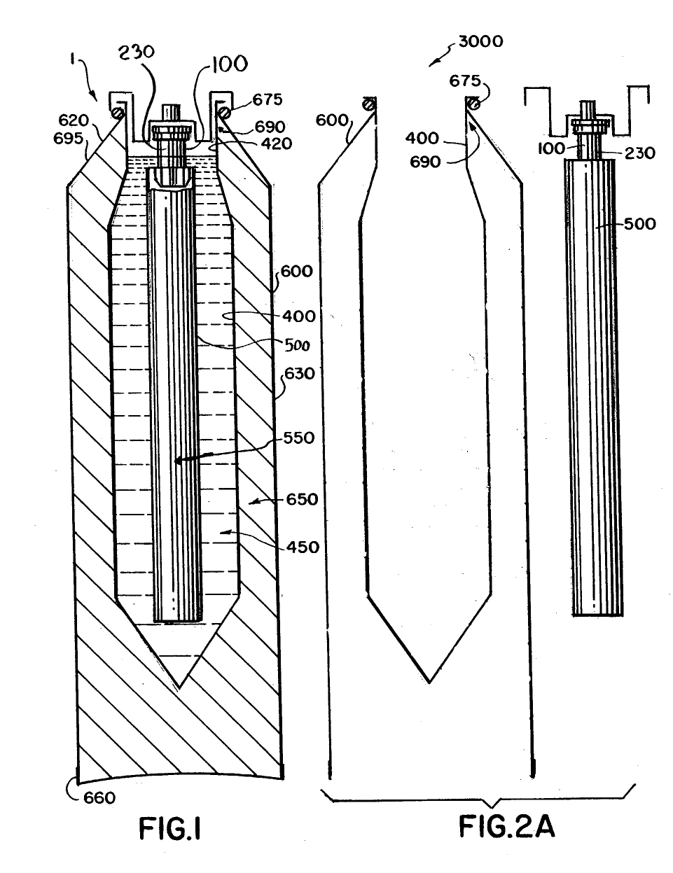

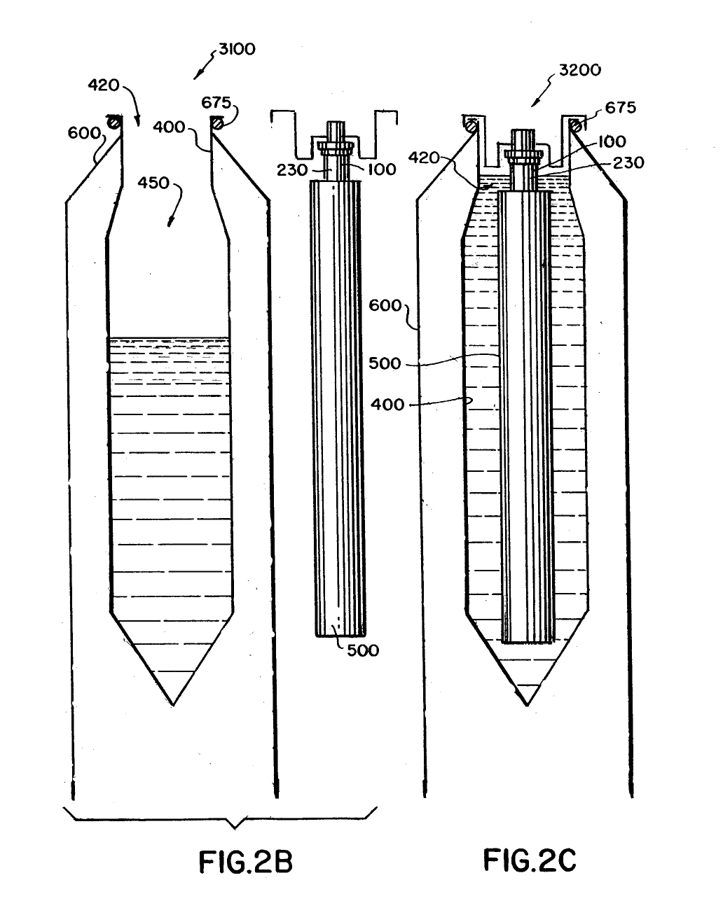

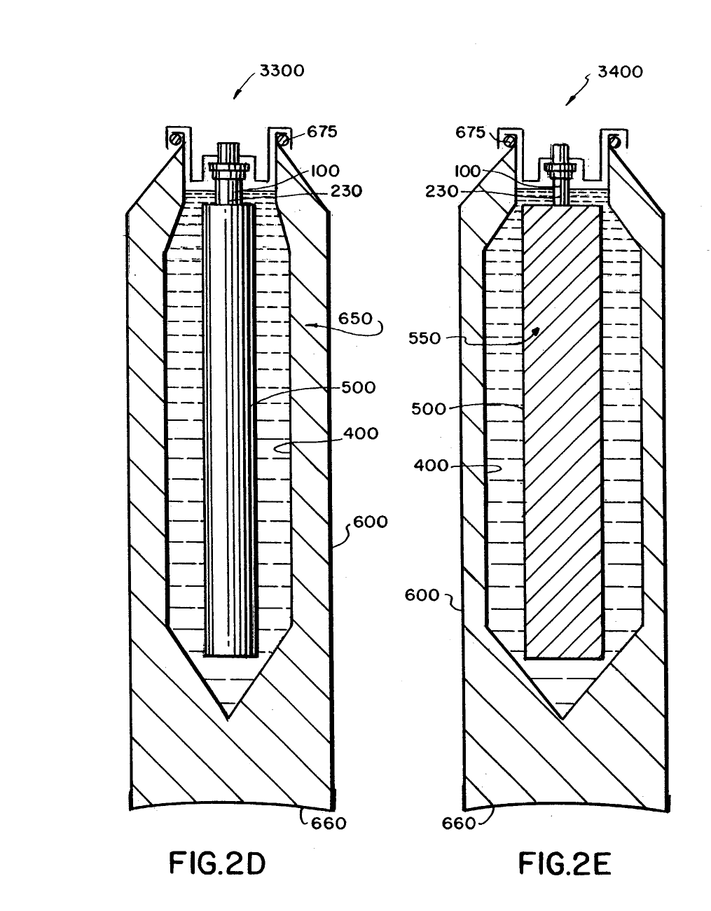

Referring to FIGS. 2a through 2e, the following steps can be taken to fill pressurized container 1 with products, illustratively, a hair dye product as previously described. Referring to FIG. 2a, first chamber 400 is inserted into aerosol canister 600 through canister opening 690 and fittingly engaged with canister rim 675, as in step 3000. Referring to FIG. 2b, the developer is then filled into second volume 450 through chamber opening 420, as in step 3100. Referring to FIG. 2c, second chamber 500 is inserted into first chamber 400 through chamber opening 420, as in step 3200. Valve system 100 is crimped on canister rim 675, and aerosol canister 600, first chamber 400 and second chamber 500 are sealingly engaged. Referring to FIG. 2d, first volume 650 of aerosol canister 600 is then pressurized through bottom end 660, which is grommetted, as in step 3300. Referring to FIG. 2e, the dye is then filled into third volume 550, as in step 3400. Preferably, the dye is filled into third volume 550 through valve system 100. In the example of valve system 100 that is disclosed in copending, commonly owned, U.S. Application entitled “Valve” (Attorney Docket No. G-00287), the dye flows through the two-way valve that is operably connected to second chamber 500, while the one-way valve that is operably connected to first chamber 400 prevents the dye from entering the first chamber. Additionally, while this filling method pressurizes first volume 650 with propellant that flows through grommetted bottom end 660, alternative propellant filling methods can be used including under the cup pressurization.

The present invention allows the mixing and dispensing of a number of substances that are stored separately. Additionally, the present invention does not require mixing of the propellant with any of the stored substances.

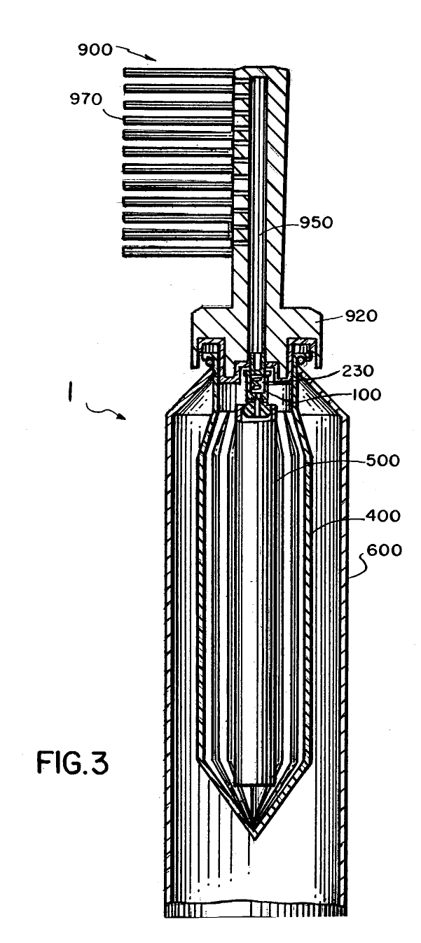

Referring to FIG. 3, an applicator of the present invention is shown and generally represented by reference numeral 900. Applicator 900 has a base 920, an applicator channel 950 and applicator members 970.

Applicator 900 is attached to container 1 at base 920. Preferably applicator 900 is removably attached to container 1. Applicator 900 is secured to valve system 100 such that movement of the applicator causes actuation of the valve system. Applicator channel 950 is in fluid communication with valve system 100 to provide for flow out of the valve system into the applicator channel. Applicator members 970 are tine-like structures that form a comb for application of the dispensed product. While applicator 900 is a comb-like device that is in fluid communication with valve system 100, alternative applicator devices can also be used with container 1 and valve system 100 that allow for application of the product after the different substances have been mixed and ejected.

The present invention having been thus described with particular reference to the preferred forms thereof, it will be obvious that various changes and modifications may be made therein without departing from the spirit and scope of the present invention as defined in the appended claims.

What is claimed is:

1. A container for separately storing under pressure two or more substances that will be mixed and then ejected from the container into atmosphere, comprising:
a rigid outer housing having an outer volume for containing a propellant;
two or more flexible inner chambers, each of said two or more inner chambers having an inner volume for containing a distinct substance, said two or more inner chambers sealingly contained in said outer volume, said outer volume and said inner volumes being in fluid isolation from each other, said propellant exerting a force on said two or more inner chambers thereby increasing pressure in said inner volumes; and
a valve system having a mixing chamber in selective fluid communication with said two or more inner chambers and the atmosphere, wherein actuation of said valve system causes said substances to eject from said two or more inner chambers into said mixing chamber where said substances mix and then eject from said mixing chamber to the atmosphere.

2. The container of claim 1, wherein said two or more inner chambers are a first inner chamber and a second inner chamber.

3. The container of claim 2, wherein said first inner chamber is sealingly contained in said second inner chamber.

4. The container of claim 3, wherein said outer housing, said first inner chamber and said second inner chamber are concentrically aligned.

5. The container of claim 2, wherein said outer housing further comprises a substantially circular open end for insertion of said first inner chamber and said second inner chamber.

6. The container of claim 5, wherein said open end comprises a flange adapted for sealing engagement with said valve system.

7. The container of claim 1, wherein said outer housing is substantially cylindrical.

8. The container of claim 1, wherein said two or more inner chambers are substantially cylindrical.

9. The container of claim 1, wherein said outer housing is made of aluminum.

10. The container of claim 1, wherein said two or more inner chambers are adjacently aligned.

11. A container for separately storing under pressure two or more substances that will be mixed and then ejected from the container into atmosphere, comprising:
a rigid outer housing having an outer volume for containing a distinct substance;
two or more flexible inner chambers, each of said two or more inner chambers having an inner volume, wherein one of said two or more inner chambers contains a propellant and the other of said two or more inner chambers contains a distinct substance, said two or more inner chambers being sealingly contained in said outer volume, said outer volume and said inner volumes being in fluid isolation from each other, said propellant exerting a force on said other of said two or more inner chambers and said outer volume for increasing pressure in said inner volume of said other of said two or more inner chambers and said outer volume; and
a valve system having a mixing chamber in selective fluid communication with said other of said two or more inner chambers, said outer housing and the atmosphere, wherein actuation of said valve system causes said substances to eject from said other of said two or more inner chambers and said outer housing into said mixing chamber where said substances mix and then eject from said mixing chamber to the atmosphere.

12. The container of claim 11, wherein said two or more inner chambers are a first inner chamber and a second inner chamber.

13. The container of claim 12, wherein said first inner chamber is sealingly contained in said second inner chamber.

14. The container of claim 13, wherein said outer housing, said first inner chamber and said second inner chamber are concentrically aligned.

15. The container of claim 12, wherein said outer housing further comprises a substantially circular open end for insertion of said first inner chamber and said second inner chamber.

16. The container of claim 15, wherein said open end comprises a flange adapted for sealing engagement with said valve system.

17. The container of claim 11, wherein said outer housing is substantially cylindrical.

18. The container of claim 11, wherein said inner chambers are substantially cylindrical.

19. The container of claim 11, wherein said outer housing is made of aluminum.

20. The container of claim 11, wherein said two or more inner chambers are adjacently aligned.

21. A method of filling a first substance and a second substance in a container, the container having a rigid outer housing, a first flexible inner chamber and a second flexible inner chamber in fluid isolation from each other, and a valve system having a mixing chamber in selective fluid communication with the first and second inner chambers and the atmosphere, for selectively mixing and then ejecting the first substance and the second substance, the method comprising the steps of:
inserting the first inner chamber into the outer housing;
filling the first inner chamber with the first substance;
inserting the second inner chamber into the outer housing;
sealingly securing the valve system to the outer housing, the first inner chamber and the second inner chamber so that the first inner chamber and the second inner chamber are in fluid communication with the mixing chamber;
filling the outer housing with a propellant; and
filling the second inner chamber with the second substance.

22. The method of claim 21, wherein the second inner chamber is inserted into the first inner chamber.

23. The method of claim 21, wherein the second substance is filled into the second inner chamber through the valve system.
